(19) United States
(12) Patent Application Publication
(10) Pub. No.: US 2006/0010773 A1
(43) Pub. Date: Jan. 19, 2006

(54) Guide roller of slide door for vehicle

(75) Inventors: Takumi Nomura, Inuyama (JP); Teruo Abe, Inuyama (JP); Hiroshi Naito, Inuyama (JP); Yoshichika Ito, Kariya (JP)

Correspondence Address: BROWDY AND NEIMARK, P.L.L.C.;624 NINTH STREET, NW, SUITE 300, WASHINGTON, DC, 20001-5303, US

(73) Assignees: Daido Metal Company Ltd., Naka-ku (JP); Aisin Seiki Kabushiki Kaisha, Kariya-shi (JP)

(21) Appl. No.: 11/177,290

(22) Filed: Jul. 11, 2005

(30) Foreign Application Priority Data
Jul. 15, 2004 (JP) 2004-2090101

(51) Int. Cl. E05F 11/40

(52) U.S. Cl. 49/362

(57) ABSTRACT

A bearing type of guide roller capable of being reliably prevented from falling off a rail is provided. A guide roller is constituted from a support shaft fixed to a support member by caulking, a ring-shaped outer ring made of bearing steel disposed to surround an outer periphery of the support shaft via a plurality of bearings, a covering member made of synthetic resin covering an outer peripheral surface of the outer ring. The ring-shaped outer ring has a flange part integrally formed on an upper end of the outer peripheral surface thereof, and an upper end of the support shaft projects from an upper end surface of the ring-shaped outer ring. Therefore, even if the covering member is broken, the flange part interferes with the rail, so that falling off of the guide roller from the rail can be more reliably prevented.

### BACKGROUND OF THE INVENTION

1. Field of the Invention

The present invention relates to a guide roller which rolls along a rail provided on a vehicle body side, and is rotatably supported by a support member connected to a slide door.

2. Description of the Prior Art

In a slide door of a vehicle, an upper guide roller provided in an upper portion of a front end of the slide door, a center guide roller provided in a central portion of a rear end in a height direction, and a lower guide roller provided in a lower portion of the front end are rollably engaged with an upper rail provided in an upper edge portion of a vehicle body opening, a center rail provided in a central portion in the height direction of a side wall of a vehicle body rear part adjacent to the vehicle body opening, and a lower rail provided in a lower edge part of the vehicle body opening, so that to the slide door is slidably supported along the vehicle body side wall and thereby the slide door can be opened and closed by the slide of this slide door.

As a guide roller of a slide door, a bearing type of roller in which synthetic resin is coated on an outer periphery of an outer ring is used as shown in JP-A-2003-176661 (especially see FIG. 3), for example. The reason that the bearing type of guide roller is used like so is that if a guide roller which is constructed as a roller of a resin solid type with a small number of components is used, there is the disadvantage that the resin solid roller is partially worn due to the load of the slide door to disturb smooth rotation, and in the worst case, the resin solid roller is broken, so that the slide door falls off (runs off) the vehicle body. In the case of the bearing type of guide roller, at least a structure body of the roller is an outer ring made of a metal (bearing steel), and therefore, there are the advantages that the roller itself is difficult to break and, even if the resin part is broken, the slide door is difficult to fall off the vehicle body.

### BRIEF SUMMARY OF THE INVENTION

However, in the case of the guide roller shown in JP-A-2003-176661, since an outer peripheral surface and an upper end surface of the outer ring are coated with a resin part, when the resin part is broken, it is difficult to say that the guide roller is reliably prevented from falling from a rail even if the structure body of the roller is the outer ring. Since the resin part also covers the upper end surface of a support shaft, it is difficult to adopt relatively easy fastening structure such as caulking when fixing the support shaft to the support member, and there is the possibility that the fastening structure becomes complicated. Further, in the case of the guide roller shown in JP-A-2003-176661, there are the problems that an effective countermeasure is not taken against the wear of a track recessed part of the outer ring of the roller which is adapted to abut on a plurality of bearings, and a track recessed part of the support shaft, and that a portion which has been contacted with the guide rail at a temperature during ED (electro diptation) performed as the slide door is mounted to the vehicle remains as a flat surface on the covering member of the synthetic resin, so that the smooth movement of the slide door is inhibited at the time of use. The present invention is made in view of the above described circumstances, and an object thereof is to provide a bearing type of guide roller capable of being prevented from falling off a rail more reliably.

A solving means which is adopted by the present invention with reference to the drawings will be explained. As shown in FIGS. 1 and 3, the invention according to claim 1 is characterized in that, in a guide roller 20 which rolls along a center rail 3 (guide rail) provided on a vehicle body outer plate 1 (vehicle body side) and is rotatably supported by a support member 10 connected to a slide door 9, the above described guide roller 20 is configured from a support shaft 21 fixed to the above described support member 10 by caulking, a ring-shaped outer ring 28 made of bearing steel disposed to surround an outer periphery of the support shaft 21 via a plurality of bearings 26, and a covering member 32 made of synthetic resin covering an outer peripheral surface of the outer ring 28, and the above-described support shaft 21 has an upper end projecting from an upper end surface of the above described ring-shaped outer ring.

The invention according to claim 2 is characterized in that, in the guide roller 20 according to claim 1, the above described flange part is also formed on a lower end of the outer peripheral surface of the above described ring-shaped outer ring 28.

The invention according to claim 3 is characterized in that, in the guide roller 20 according to claim 1 or claim 2, induction hardening treatment is applied to a track recessed part 23 on which the above described bearing 26 of the above described support shaft 21 abuts.

Further, the invention according to claim 4 is characterized in that, in the guide roller 20 according to any one of claims 1 to claim 3, the above described covering member 32 is made of a fiber reinforced type of synthetic resin which includes 46 nylon having a high softening temperature as a main component and is mixed with special fibers. As the special fibers mixed into the covering member 32, aramid fibers and carbon fibers are cited.

In the invention according to claim 1, since the flange part 29 is formed at the upper end of the outer peripheral surface of the outer ring 28, even if the covering member 32 is broken, the flange part 29 interferes with the rail, and therefore, it is possible to prevent the guide roller 20 from falling off the rail more reliably as compared with the prior art. Also, since the upper end of the support shaft 21 projects from the upper end surface of the outer ring 28, caulking can be applied to fixing structure of the support shaft 21 against the support member 10, and therefore, the support shaft 21 can be fixed to the support member 10 easily and at low cost, as compared with the prior art.

In the invention according to claim 2, since the flange part 29 is formed also at the lower end of the outer peripheral surface of the outer ring 28 to hold the covering member 32 with the flange part 29, the covering member 32 can be prevented from falling off the outer ring 28.

In the invention according to claim 3, since the induction hardening treatment is applied to the track recessed part 23 of the support shaft 21, wear of the guide roller 20 and the bearing 26 can be suppressed while ensuring the fixing structure by caulking.

In the invention according to claim 4, since the covering member 32 is made of a fiber reinforced type of synthetic resin in which the 46 nylon, as a main component, having a high softening temperature is mixed with the special fibers, the strength can be enhanced, and the portion of the covering member 23 made of the synthetic resin, which portion has abutted on the rail, does not become a flat surface due to the temperature at the time of ED, and therefore, it is possible to maintain smooth rolling of the guide roller with respect to the rail.

### BRIEF DESCRIPTION OF THE SEVERAL VIEWS OF THE DRAWINGS

FIG. 1 is a sectional view of a center rail part to which a guide roller 20 according to the present embodiment is applied;

FIGS. 2A, 2B and 2C are a front view, a plane view and a right side view, respectively, showing an outline of a center guide roller mechanism to which the guide roller 20 is applied; and

FIG. 3 is a partially cutaway front view showing the internal structure of the guide roller.

### DETAILED DESCRIPTION OF THE INVENTION

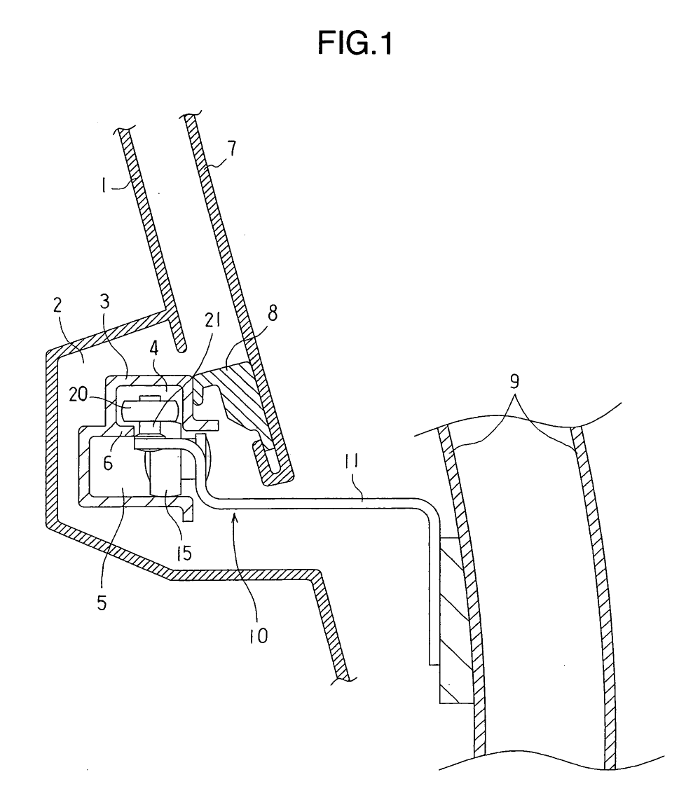

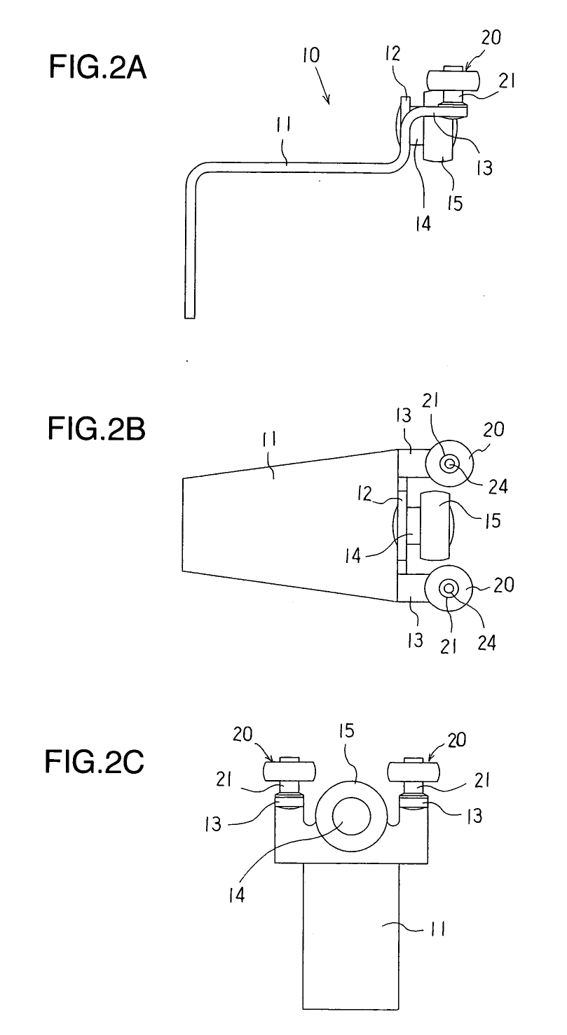

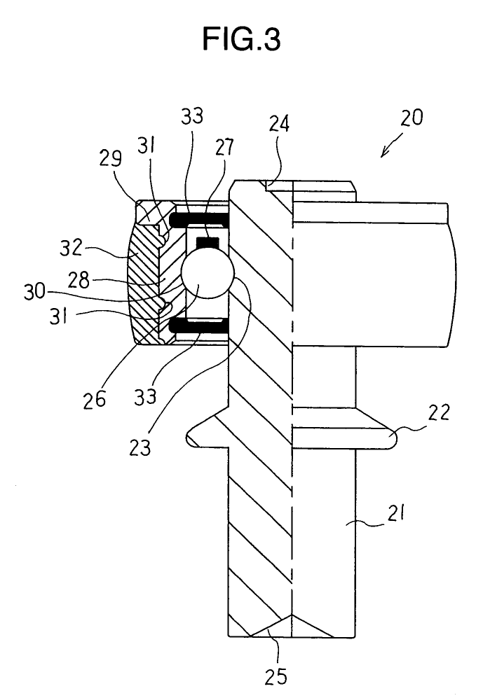

Hereinafter, one embodiment of a guide roller of a slide door for a vehicle according to the present invention will be explained with reference to FIGS. 1 to 3. FIG. 1 is a sectional view of a center rail part to which a guide roller 20 according to the present embodiment is applied, FIGS. 2A, 2B and 2C are respectively a front view, a plane view and a right side view, respectively, showing an outline of a center guide roller mechanism 10 to which the guide roller 20 is applied, and FIG. 3 is a partially cutaway front view showing the internal structure of the guide roller 20.

As described in the above, the slide door for the vehicle is adapted to able to be opened and closed by a slide of this slide door by rollably engaging an upper guide roller provided in an upper part of a front end of the slide door, a center guide roller provided in a central part in a height direction of a rear end, and a lower guide roller provided in a lower part of the front end with an upper rail provided in an upper edge part of a vehicle body opening, a center rail provided in a central part in the height direction of a side wall in a rear part of the vehicle body adjacent to the vehicle body opening and a lower rail provided in a lower edge part of the vehicle body opening, respectively, to slidably support the slide door along the vehicle body side wall. The embodiment shown in the drawings shows one in which the guide roller according to the present invention applied to the above described center guide roller mechanism 10.

As shown in FIG. 1, a center rail 3 is attached in a recessed part 2 having a substantially horseshoe-shaped section, of which an opening is opened sideward on a side wall of a rear part of a vehicle body outer plate 1. The center rail 3 is formed so that a guide roller chamber 4 in which the guide roller 20 is housed in its upper position and a support roller chamber 5 in which a support roller 15 is housed are vertically communicated with each other. A partition projection piece 6 is provided so as to project inward from one side wall which partitions off the guide roller chamber 4 and the support roller chamber 5. This partition projection piece 6 is provided for preventing the guide roller 20 from falling off the center rail 3, and thereby preventing the slide door 9 from falling off. The recessed part 2 is covered with a detachable center rail cover 7, while a space holding member 8 which is in contact with the center rail 3 to hold the space is fixed to an inside of a lower end of the center rail cover 7.

The support roller 15 and the guide roller 20 of the center guide roller mechanism 10 are rollably engaged with the center rail 3 constructed as described above, and connected to the slide door 9 via a support member 11 of the center guide roller mechanism 10. Here, the center guide roller mechanism 10 will be explained with reference to FIGS. 1 and 2.

The center guide roller mechanism 10 is constituted from the support member 11 formed into a crank shape, and the support roller 15 and the guide roller 20 which are rotatably mounted to a support roller mounting piece 12 and a guide roller mounting piece 13 which are formed in an upper part of one end of the support member 11. More specifically, one end side (upper end side) of the support member 11 is raised in the vertical direction, and a center portion of that raised part is the support roller mounting piece 12. Both left and right sides of the raised part are further projected in the horizontal direction to be the guide roller mounting pieces 13. A support shaft 14 rotatably supporting the support roller 15 is fixed to the support roller mounting piece 12 by caulking. Also, a support shaft 21 rotatably supporting the guide roller 20 is fixed to the guide roller mounting piece 13 by caulking. Meanwhile, the other end side of the support member 11 forms a mounting piece which is suspended downward to be connected to the slide door 9.

In the center guide roller mechanism 10 constructed as describe above, the support roller 15 is housed in the support roller chamber 5 of the center rail 3 and rolls while abutting on a bottom surface of the support roller chamber 5 in accordance with sliding movement of the slide door 9, and the guide roller 20 is housed in the guide roller chamber 4 of the center rail 3 and rolls while abutting on left and right side surfaces of the guide roller chamber 4 in accordance with the sliding movement of the slide door 9. While the support roller 15 is configured from a bearing type of roller of which an outer periphery is coated with a covering member made of synthetic resin or rubber, the support roller 15 may have the same structure as the guide roller 20 which constitutes the gist of the present invention.

Next, a detailed construction of the guide roller 20 will be explained with reference mainly to FIG. 3. The guide roller 20 is configured from the support shaft 21 fixed to the guide roller mounting piece 13 of the above described support member 11 by caulking, a ring-shaped outer ring 28 disposed to surround an outer periphery of the support shaft 21 via a plurality of bearings 26, and a covering member 32 made of synthetic resin covering an outer peripheral surface of the outer ring 28.

The support shaft 21 is formed from a columnar member made of medium carbon steel (S35C, for example), and has a clamp holding projection 22 formed in its substantially middle portion, which projection abuts on the guide roller mounting piece 13 when fixed by caulking, and recessed parts 24 and 25 for caulking formed on its upper and lower end surfaces, into which recessed parts a pressing member for caulking is to be charged. Further, an arc-shaped track recessed part 23 on which the bearing 26 abuts is formed in an upper portion of the support shaft 21. This region of the track recessed part 23 is subjected to induction hardening treatment. By constructing the support shaft 21 using medium carbon steel, the support shaft 21 is easily fixed to the above described guide roller mounting piece 13 by caulking, and by performing induction hardening for the track recessed part 23 of which wear is calculated, durability is provided against frictional wear caused by the bearing 26. As a result of performing the induction hardening treatment, the hardness of the track recessed part 23 becomes Hv 700 or more. Further, rustproofing treatment using manganese phosphate is performed for the entire support shaft 21.

A plurality of bearings 26 are adapted to be equidistantly disposed by a retainer 27 between the above described support shaft 21 and the outer ring 28. Grease is applied between the bearings 26. Further, in the ring-shaped outer ring 28 disposed to surround the outer periphery of the support shaft 21, a flange part 29 is integrally formed at an upper end of the outer peripheral surface thereof, and an arc-shaped track recessed part 30 on which the above described bearing 26 abuts is formed on its inner peripheral surface. Furthermore, falling-off prevention recessed parts 31 which engage with the covering member 32 are formed in two upper and lower locations on an outer peripheral surface of the ring-shaped outer ring 28. The outer ring 28 is constructed by bearing steel (SUJ-2, for example), and vacuum hardening treatment is performed for the entire outer ring 28. By performing the vacuum hardening treatment for the entire outer ring 28 like this, the hardness of the track recessed part 30 becomes HRc 58 to 65, and therefore, the outer ring 28 has the durability against the friction wear by the bearing 26.

The covering member 32 made of synthetic resin is composed of a fiber reinforced type of synthetic resin in which 46 nylon having a softening temperature higher than that of nylon 66 is included as a main component, and special fibers such as aramid fibers and carbon fibers are mixed by 10 wt % or less (desirably 2 to 6 wt %) therewith. This covering member 32 is provided to cover the outer peripheral surface of the outer ring 28 by insert molding. When the covering member is covered, an upper end of the covering member 32 is hooked at the flange part 29 of the outer ring 28 and the covering member 32 engages with the falling-off prevention recessed parts 31. Therefore, the covering member 32 made of the synthetic resin does not fall off the outer ring 28. Further, since the covering member 32 made of the synthetic resin is made of the fiber reinforcement type of synthetic resin in which the 46 nylon having a high softening temperature is included as the main component and the special fibers are mixed therewith, strength can be enhanced, and the portion of the covering member 32 made of the synthetic resin which portion has abutted on the guide rail does not become a flat surface due to the temperature at the time of ED. Therefore, smooth movement of the slide door 9 can be maintained. Also, by an embodiment in which the flange part 29 is also formed at the lower end of the outer ring 28 and the covering member 32 is held with the flange parts 29, the covering member 32 made of the synthetic resin can be prevented from falling off the outer ring 28.

Further the flange part 29 formed at the upper end of the outer peripheral surface of the outer ring 28 is not covered with the covering member 28, and is able to contact with the left and right side surfaces of the guide roller chamber 4. Therefore, even if the covering member 32 is broken, the guide roller 20 is prevented from falling off the guide roller chamber 4 more reliably as a result that the flange part 29 which is difficult to wear by the vacuum hardening treatment interferes with the left and right side surfaces, and the center guide roller mechanism 10 is prevented from falling off the center rail 3 to cause the slide door to fall off the vehicle body ultimately.

In the assembled state of the guide roller 20 shown in FIG. 3, the upper end of the support shaft 21 protrudes upward (upward in FIG. 3) from the upper end surface of the outer ring 28. In this case, when mounting the guide roller 20 to the guide roller mounting piece 13, it is possible to hold the support shaft 21 by a jig or the like, while locating the outer ring 28 on the support shaft 21. Thereby, the support shaft 21 can be fixed to the guide roller mounting piece 13 by caulking, and the guide roller 20 can be mounted to the guide roller mounting piece 13 by using relatively easy fixing structure.

In the guide roller 20 consisting of the support shaft 21, the bearing 26, the outer ring 28 and the covering member 32 as described above, the upper surface and the lower surface of the outer ring 28 are sealed with seal rings 33 when the support shaft 21 is assembled into the outer ring 28 so that a foreign matter does not enter the inside thereof.

In the embodiment explained above, the case where the guide roller 20 is assembled into the center guide roller mechanism 10 is explained, but the present invention can be applied to the guide roller which is assembled into the upper guide roller mechanism or the lower guide roller mechanism.

1. A guide roller of a slide door for a vehicle, the guide roller being adapted to roll along a rail provided on a vehicle body side, and being rotatably supported by a support member connected to a slide door, the guide roller comprising:
a support shaft fixed to the support member by caulking;
a ring-shaped outer ring made of bearing steel disposed to surround an outer periphery of the support shaft via a plurality of bearings; and
a covering member made of synthetic resin covering an outer peripheral surface of the ring shaped outer ring,
wherein the ring-shaped outer ring is integrated with a flange part formed at least at an upper end of the outer peripheral surface thereof, and
an upper end of the support shaft projects from an upper end surface of the ring-shaped outer ring.

2. The guide roller of the slide door for the vehicle according to claim 1, wherein the flange part is formed also at a lower end of the outer peripheral surface of the ring-shaped outer ring.

3. The guide roller of the slide door for the vehicle according to claim 1, wherein a track recessed part of said support shaft on which part the bearing abuts is an induction hardened part.

4. (canceled)

5. The guide roller of the slide door for the vehicle according to claim 2, wherein a track recessed part of said support shaft on which part the bearing abuts is an induction hardened part.

6. The guide roller of the slide for the vehicle according to claim 1, wherein said covering member is made of a fiber reinforced synthetic resin in which 46 nylon having a high softening temperature is contained as a main component mixed with other fibers.

7. The guide roller of the slide for the vehicle according to claim 2, wherein said covering member is made of a fiber reinforced synthetic resin in which 46 nylon having a high softening temperature is contained as a main component mixed with other fibers.

8. The guide roller of the slide for the vehicle according to claim 3, wherein said covering member is made of a fiber reinforced synthetic resin in which 46 nylon having a high softening temperature is contained as a main component mixed with other fibers.

9. The guide roller of the slide for the vehicle according to claim 5, wherein said covering member is made of a fiber reinforced synthetic resin in which 46 nylon having a high softening temperature is contained as a main component mixed with other fibers.
